(19) United States
(12) Patent Application Publication
(10) Pub. No.: US 2025/0213041 A1
(43) Pub. Date: Jul. 3, 2025

(54) Recliners for the Disabled

(71) Applicant: Maria Connor, Starr, SC (US)

(72) Inventor: Maria Connor, Starr, SC (US)

(21) Appl. No.: 18/400,382

(22) Filed: Dec. 29, 2023

(51) Int. Cl. A47C 1/024; A47C 7/54; A61G 5/10

(52) U.S. Cl. CPC A47C 1/024; A47C 7/541; A61G 5/10

(57) ABSTRACT

The Connor Collection of living room furniture including a Barcalounger, a love seat, and a sofa all having removable arms to provide easier access to the seats for those in a wheel chair or those others physically compromised. In addition, when legs are raised on any of the pieces of furniture, there is a motion/heat sensor underneath the footrest that notifies the sitting person that someone or something is underneath their feet.

### FIELD OF THE INVENTION

The invention relates to methods and apparatus for improving and modifying a recliner for ease of use for those disabled.

### BACKGROUND OF THE INVENTION

Disabled people are often in a wheelchair either for a short while after an accident or illness or for a long while with chronic illnesses. Getting in and out of the wheelchair and into a recliner or loveseat or couch, is and has been pretty much impossible unless someone very strong can help to lift them from the wheelchair into the recliner or loveseat or couch. Oftentimes the arms of the couch, recliner or loveseat, impede the disabled person from easily sitting in these comfortable pieces of furniture. If confined to a wheelchair, a person may not have strength in their arms to pull themselves from the wheelchair into an open seat on a sofa or loveseat just to join the rest of the family.

### SUMMARY OF THE INVENTION

This recliner will help people who must use wheelchairs because they had a stroke or ALS. The arms lift off and the ones that must stay in the wheelchair and have use of their arms can slide themselves into the chair. Then place the arm back on and they can recline and lift their legs. This is also for others who must be lifted with a body lift. It will allow the caregiver to remove the arm so they don't have to lift them up so high to set them in a comfortable chair and can be out of their bed and out with their family. It has built in controls on the arm, instead of a corded one that can get in the way, sat on or fall off onto the floor. The arms may also open up to provide additional storage. The recliner also has sensor lights under the legs portion so no small animal can accidentally get trapped hurt or killed. The collection of furniture is called “The Connor Collection” because there is not just a recliner, but also a sofa and a loveseat in this collection, for those that need it. There is a battery located on the side of the chair in case the power goes out, so the person sitting in the chair can get out. On the Connor Collection, the ones with the removable arms. The couch will also in the same way pull up in between the seats like the love seat. Children will want to sit with them if their parent who is next to them. Also, with the battery backup battery, if the items lose electricity and are on battery power only the sensors underneath turn off to save the backup battery. Yet when the chair goes back to electricity, when the power turns back on, the sensors underneath turn back on. The same for the ones without removable arms.

### BRIEF DESCRIPTIONS OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates the side view of the Connor Collection Barcalounger chair 1 which shows the heat/motion sensors 3 underneath the footrest 5 when the legs are up.

FIG. 2 illustrates the front view of the Connor Collection Barcalounger chair 1 which shows the chair controls 6 located on both the arm rests 4, which are removable.

FIG. 3 illustrates the love seat 7 of the Connor Collection with chair controls 6 located on each armrest 4 on each side of the love seat 7 and also shows the heat/motion sensors 3 underneath the footrest 5 when the legs are up.

FIG. 4 illustrates the side view of the Connor Collection Barcalounger chair 1 where the back of the Barcalounger chair 1 is lifting up.

FIG. 5 illustrates the divider control 10 of the Connor Collection sofa 16 either the supports 15 can stay where it is or can be removed from the sofa 16.

FIG. 6 illustrates the chair control 6 of any of the Connor Collection chairs.

FIG. 7 illustrates the removable arm rest 4 when it has been lifted off the chair, and it has a metal plate 13 with many metal pegs 11 sticking out of it, and in the chair spot where the arm rest has come from is a metal plate 13 with corresponding holes for every peg 11 on the arm rest 4.

FIG. 8 illustrates the Connor Collection sofa 16, with two supports 15 in between the three seats on the sofa 16, that are retractable for more intimacy between those seated.

### DETAILED DESCRIPTION OF THE INVENTION

Reference will now be made in detail to embodiments of the invention, examples of which are illustrated in the accompanying drawing. Whenever possible, the same reference numbers will be used throughout the drawings to refer to the same of like parts.

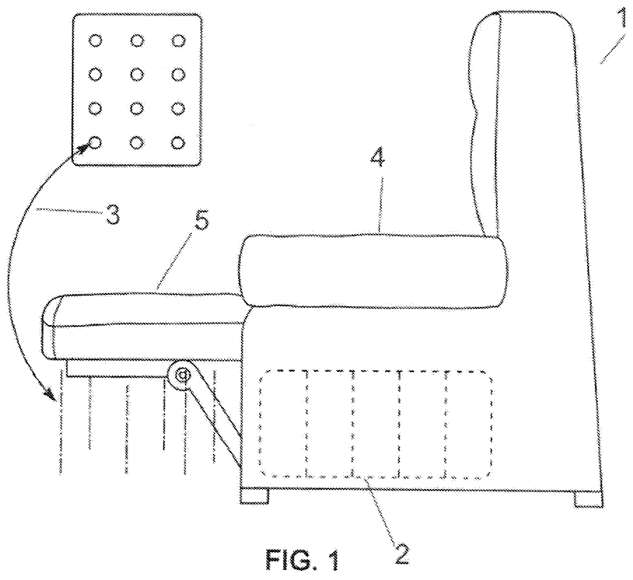

FIG. 1 illustrates the side view of the Connor Collection Barcalounger chair 1 with removable arm rests 4 to facilitate access for someone in a wheelchair or otherwise physically compromised, and the footrest 5 is up. When the footrest 5 is up, a motion/heat sensor 3 located underneath the footrest 5, activates, alerting the seated person when something or someone is underneath the footrest 5. Also shown on the side of the chair are back-up batteries 2 for the chair control 6.

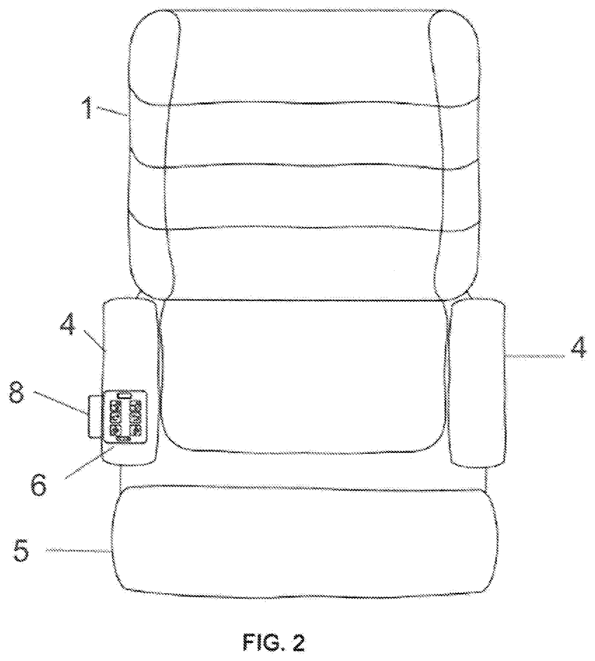

FIG. 2 illustrates the front view of the Conner Collection Barcalounger chair 1, where the chair controls 6 are shown on one arm rest 4 of the chair 1. Either arm rest 4 of the chair 1 can be removed from the chair 1 to facilitate someone in a wheelchair or otherwise physically compromised access to the chair 1.

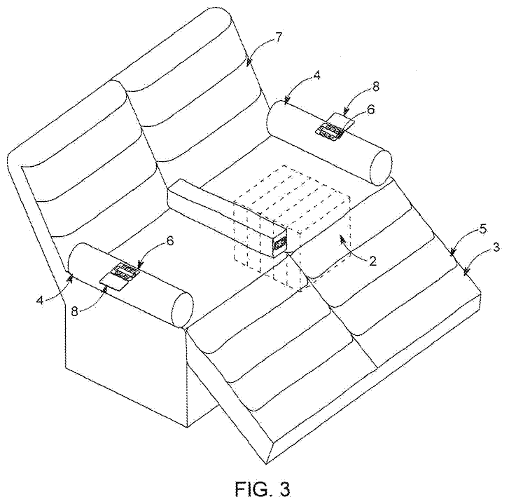

FIG. 3 illustrates the love seat 7 of the Connor Collection with a top down view, showing the chair controls 6 located on both arm rests 4. The love seat 7 has removable arm rests 4 just like the Barcalounger chair 1 and also has the motion/heat sensors 3 underneath the footrest 5, such that when the legs are raised, either the legs won't go down, or a noise will be made alerting the sitting person that someone or something is underneath their feet.

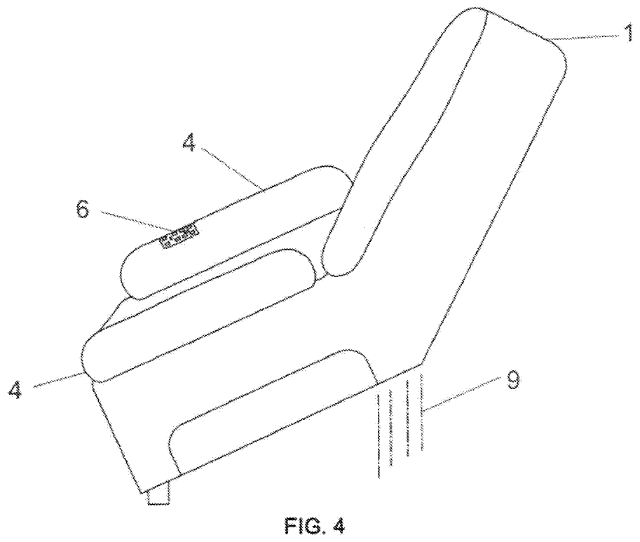

FIG. 4 illustrates a side view of the Barcalounger chair 1 such that when a person is exiting the Barcalounger chair 1, the chair 1 can raise from behind 9 to facilitate egress from the chair 1.

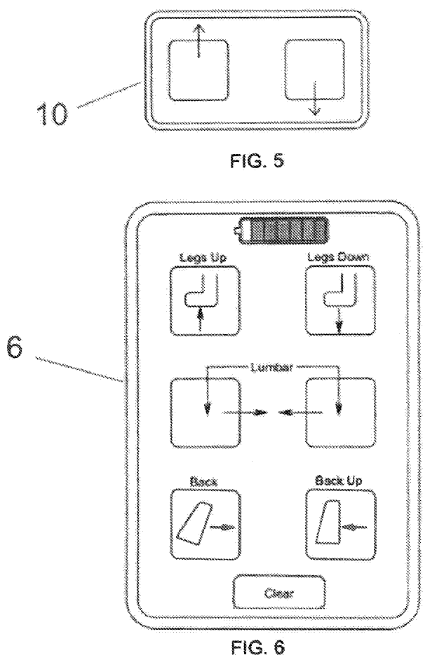

FIG. 5 illustrates the chair controls 10 of the Connor Collection sofa 16, which will either allow the person sitting on the sofa 16 to remove the central arm rests, thereby allowing family members to sit very close to one another on the sofa 16.

FIG. 6 illustrates the chair controls 6 of the Conner Collection Barcalounger chair 1, loveseat, 7 and sofa 16, showing lumbar support, and legs up or down, and the back of the chair back or more upright. These chair controls 6 are located on the arm rests of the Barcalounger 1, the love seat 7 and the outside arm rests 4 of the sofa 16. They can be battery powered or solar powered.

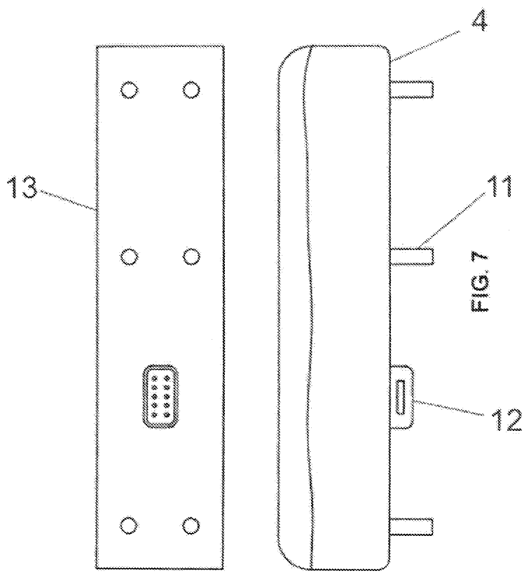

FIG. 7 illustrates a magnification of the arm rest 4 when the arm rest 4 is removed from the Barcalounger chair 1, the loveseat 7 and the sofa 16, the arm rest 4 portion has several pegs 11, sticking out from it, and the portion where the arm rest 4 attaches to the chair 13 has a metal plate 13 with corresponding holes for the several pegs 11, to securely attach the arm rest 4 to the chair, and then the arm rest 4 locks into place with lock 12.

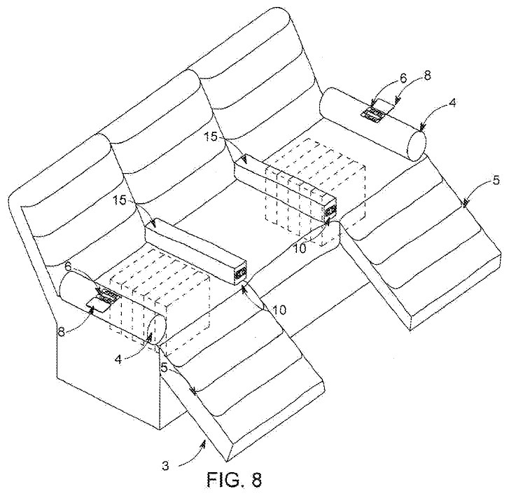

FIG. 8 illustrates the sofa 16 of the Connor Collection with retractable arm rests 4 as with the other pieces of the Connor Collection, and also heat/motion sensors 3 underneath the footrests 5 when the legs are raised, so either the legs won't go down, or a noise will be made alerting the sitting person that someone or something is underneath their feet. There is also a padded cover 8 to the chair controls 6 when the chair controls 6 are not in use so the arm rest 4 is comfortable for the person sitting there and putting their arm on the arm rest 4. The two supports 15 in between the seats on the sofa 16 also have a control 10 such that one or both supports 15 may be removed from the sofa to permit people sitting on the sofa 16 to sit very close to one another.

### Other Embodiments

While several embodiments have been shown and described, the above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments on the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Furthermore, the disclosed embodiments include a plurality of features that are described in concert but which can be used independently and/or combined with other features. The present invention is not limited to only those embodiments that include all of these features or that provide all of the stated benefits, except to the extent otherwise expressly set forth in the issued claims. Any reference to claim elements in the singular, for example, using articles “a,” “an,” “the” or “said” is not to be construed as limiting the element to the singular.

Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

What is claimed is:

1. A sitting apparatus comprising an arm rest and a seat, wherein said arm rest, lifts off of said sitting apparatus, which allows an occupant in a wheelchair ease of access to said seat.

2. The sitting apparatus of claim 1 wherein said arm rests stays off the sitting apparatus until said occupant of the wheelchair has slid into the seat of said sitting apparatus.

3. The apparatus of claim 1 wherein the arm rest has metal posts sticking out of the bottom of the arm rest.

4. The apparatus of claim 3, wherein the chair in the spot where the arm goes, has a metal plate filled with holes to fit exactly the metal posts from the bottom of the arm rest, such that when the arm rest is on the sitting apparatus, an electrical connection is made.

5. The apparatus of claim 1, wherein for every sitting apparatus, underneath the leg portion of the sitting apparatus that goes up and down, when the legs are up, there are motion/heat sensors located underneath the legs portion that keep the legs up if someone or something is detected under the legs.

6. The apparatus of claim 1, wherein the sitting apparatus also has a chair controller which controls whether you want legs up or down, whether you want lumbar support or not, whether you want the back of the seat to go back or to go back up.

7. The apparatus of claim 1, wherein the sitting apparatus is a Barcalounger.

8. The apparatus of claim 1, wherein the sitting apparatus is a loveseat.

9. The apparatus of claim 1, wherein the sitting apparatus is a sofa.

10. The apparatus of claims, 7, 8 and 9 comprise the Connor Collection of furniture.
